(19) United States
(12) Patent Application Publication
(10) Pub. No.: US 2026/0171382 A1
(43) Pub. Date: Jun. 18, 2026

(54) METHOD FOR MANUFACTURING QUADRUPOLE MASS FILTER, AND QUADRUPOLE MASS SPECTROMETER

(71) Applicant: SHIMADZU CORPORATION, Kyoto-shi (JP)

(72) Inventors: Manabu UEDA, Kyoto-shi (JP); Wataru FUKUI, Kyoto-shi (JP); Hiroki MIYASHIRO, Kyoto-shi (JP)

(21) Appl. No.: 19/404,236

(22) Filed: Dec. 1, 2025

(30) Foreign Application Priority Data
Dec. 16, 2024 (JP) 2024-219626

(51) Int. Cl. H01J 49/42; H01J 49/16; H01J 49/24

(52) U.S. Cl. CPC H01J 49/4215; H01J 49/165; H01J 49/24

(57) ABSTRACT

One aspect of a method for manufacturing a quadrupole mass filter according to the present invention is a method for manufacturing a quadrupole mass filter including four rod electrodes, comprising a first step (S1, S2) of forming a hyperbolic surface by cutting at least a part of a side surface or a peripheral surface of each of four rod-shaped members over a longitudinal direction, each of the four rod-shaped members having a length in a range of 80 mm or more and 120 mm or less, and a second step (S3) of positioning and fixing the four rod-shaped members, on which the hyperbolic surfaces are respectively formed, as rod electrodes using a holding member, such that the four rod electrodes surround a central axis and the hyperbolic surface of each rod electrode faces the central axis.

### TECHNICAL FIELD

The present invention relates to a method for manufacturing a quadrupole mass filter used in a mass spectrometer, and a quadrupole mass spectrometer using the quadrupole mass filter.

### BACKGROUND ART

In a general single quadrupole mass spectrometer, various components (compounds) contained in a sample are ionized in an ion source, the ions generated thereby are separated according to the mass-to-charge ratio (m/z) by a quadrupole mass filter, and the separated ions are detected by an ion detector.

A quadrupole mass filter generally has a configuration in which four rod electrodes, each having a substantially cylindrical outer shape, are arranged parallel to each other and spaced at equal angular intervals (90°) in a circumferential direction so as to be tangent to the outside of an inscribed circle of a predetermined radius centered on a straight axis. A voltage of +(U+Vcosωt), which is a superposition of a radio frequency (RF) voltage +Vcosωt on a DC voltage +U, is applied to two rod electrodes facing each other across the central axis, which is also the ion optical axis. A voltage of −(U+Vcosωt), which is a superposition of an RF voltage −Vcosωt, whose phase is inverted (differs by 180°) from the RF voltage +Vcosωt, on a DC voltage −U, whose polarity is different from the DC voltage +U, is applied to the other two rod electrodes. When the voltage value U of the DC voltage and the amplitude value V of the RF voltage are set to predetermined values corresponding to m/z, only ions having that m/z selectively pass through the quadrupole electric field within the quadrupole mass filter.

In a quadrupole mass filter, it is known that making the rod electrodes longer in the axial direction is advantageous for enhancing mass resolution (mass selectivity). This is because, if the frequency ω of the RF voltage is the same, the longer the rod electrodes are in the axial direction, the more times the ions oscillate as they pass through the space surrounded by the rod electrodes, stabilizing the oscillation of the ions that should pass (conversely, making the oscillation of the ions that should not pass more reliably unstable). Furthermore, in a quadrupole mass filter, if the shape of the curved surface of each rod electrode facing the central axis is a hyperbolic surface (a surface whose contour on a plane orthogonal to the central axis is a hyperbola), an ideal quadrupole electric field can be formed in the space surrounded by the rod electrodes (see Patent Literature 1, etc.), thereby, it is known that mass resolution is enhanced and the peak shape in the mass spectrum can be improved.

### CITATION LIST

### Patent Literature

[Patent Literature 1] International Publication No. WO 2018/138838

### SUMMARY OF THE INVENTION

### Technical Problem

As described above, to achieve high mass resolution and good peak shape, it is preferable to use rod electrodes for the quadrupole mass filter that have a hyperbolic surface facing the central axis and are as long as possible in the axial direction. However, machining the side peripheral surface of the rod electrodes requires high precision on the order of microns, and forming a hyperbolic surface with high precision is significantly more difficult than forming a simple arc-shaped curved surface. Therefore, when trying to manufacture rod electrodes that have a hyperbolic surface facing the central axis and are long in the axial direction, the manufacturing process takes time, the yield is poor, and the cost becomes high. On the other hand, to reduce manufacturing costs, rod electrodes with a simple cylindrical outer shape are sometimes used, but in that case, it is inevitable that mass resolution and good peak shape are sacrificed.

The present invention has been made to solve these problems, and its main object is to provide a method for manufacturing a quadrupole mass filter that can reduce manufacturing costs while sufficiently securing performance as a quadrupole mass filter, such as high mass resolution and good peak shape, and a quadrupole mass spectrometer using a quadrupole mass filter manufactured by such a method.

In this description, the term “quadrupole mass spectrometer” includes not only a general single-type quadrupole mass spectrometer, but also all mass spectrometers equipped with a quadrupole mass filter, such as a triple quadrupole mass spectrometer in which quadrupole mass filters are arranged before and after a collision cell, and a quadrupole-time-of-flight (Q-TOF) type mass spectrometer in which a quadrupole mass filter is arranged upstream of a collision cell and a time-of-flight mass separator is arranged downstream.

### Solution to Problem

One aspect of the method for manufacturing a quadrupole mass filter according to the present invention is a method for manufacturing a quadrupole mass filter used in a mass spectrometer, comprising:
a first step of forming a hyperbolic surface by cutting at least a part of a side surface or a peripheral surface of each of four rod-shaped members over an entire length in a longitudinal direction, each of the four rod-shaped members having a length in a range of 80 mm or more and 120 mm or less; and
a second step of positioning and fixing the four rod-shaped members, on which the hyperbolic surfaces are respectively formed, as rod electrodes using a holding member, such that the four rod electrodes surround a central axis and the hyperbolic surface of each rod electrode faces the central axis.

Furthermore, one aspect of the quadrupole mass spectrometer according to the present invention comprises a quadrupole mass filter that separates ions to be measured according to m/z, wherein the quadrupole mass filter includes:
four rod electrodes having a length along a central axis in a range of 80 mm or more and 120 mm or less, and at least a surface facing the central axis being a hyperbolic surface; and
a holding member that fixes the four rod electrodes so as to surround the central axis in a state where the hyperbolic surface of each rod electrode faces the central axis.

### Advantageous Effects of Invention

The present inventor, as a result of examining the manufacturing of rod electrodes with a hyperbolic inner surface from various angles, has found that when a hyperbolic surface is formed by cutting the side surface or peripheral surface of a long rod-shaped member, the dimensional accuracy of the hyperbolic surface deteriorates due to the bending of the rod-shaped member during machining, which is the main cause of the decrease in yield in manufacturing. In other words, by shortening the rod electrodes, the bending of the rod-shaped member during machining can be reduced, and it is possible to form a hyperbolic surface with higher precision. On the other hand, as described above, shortening the rod electrodes is disadvantageous in terms of mass resolution because the number of oscillations of the ions passing through the space surrounded by the rod electrodes decreases. Therefore, the present inventor, while also considering other parameters that affect the number of oscillations, such as the velocity of the ions, experimentally and through simulations, examined a balanced range of rod lengths that can improve the manufacturing yield while maintaining performance equal to or better than the conventional one, and has completed the present invention.

According to the above aspect of the method for manufacturing a quadrupole mass filter and the quadrupole mass spectrometer of the present invention, a hyperbolic surface with good precision can be obtained with a yield that is satisfactory in terms of cost, and the rod length necessary for the separation and selection of the target ions can be secured. As a result, in the above aspect of the method for manufacturing a quadrupole mass filter and the quadrupole mass spectrometer of the present invention, the detection sensitivity can be improved while maintaining mass resolution and good peak shape equal to or better than the conventional ones, and the cost can also be sufficiently suppressed.

### BRIEF DESCRIPTION OF DRAWINGS

FIG. 1 is a schematic configuration diagram of the main parts of a single quadrupole mass spectrometer according to an embodiment of the present invention.

FIG. 2 is a schematic plan view of the quadrupole mass filter in the single quadrupole mass spectrometer of the present embodiment when viewed in the Z-axis direction.

FIG. 3 is a flowchart showing an example of the manufacturing procedure of the quadrupole mass filter used in the single quadrupole mass spectrometer of the present embodiment.

FIG. 4 is a schematic diagram showing an example of machining of a rod electrode.

FIG. 5 is a schematic diagram showing another example of machining of a rod electrode.

FIG. 6 is a diagram showing an actual measurement example of a mass spectrum obtained by analyzing PEG with m/z 1004.6 using rod electrodes with a rod length of 200 mm (conventional product).

FIG. 7 is a diagram showing an actual measurement example of a mass spectrum obtained by analyzing PEG with m/z 1004.6 using rod electrodes with a rod length of 120 mm.

FIG. 8 is a diagram showing an actual measurement example of a mass spectrum obtained by analyzing PEG with m/z 1004.6 using rod electrodes with a rod length of 80 mm.

FIG. 9 is a diagram showing an actual measurement example of a mass spectrum obtained by analyzing PEG with m/z 1893.4 using rod electrodes with a rod length of 200 mm (conventional product).

FIG. 10 is a diagram showing an actual measurement example of a mass spectrum obtained by analyzing PEG with m/z 1893.4 using rod electrodes with a rod length of 120 mm.

FIG. 11 is a diagram showing an actual measurement example of a mass spectrum obtained by analyzing PEG with m/z 1893.4 using rod electrodes with a rod length of 80 mm.

### DESCRIPTION OF EMBODIMENTS

### Supplementary Explanation of the Above Embodiment

The quadrupole mass spectrometer of the above embodiment may be used for samples that are gas, liquid, or solid. It is natural that the ionization method differs depending on the form of the sample. That is, the quadrupole mass spectrometer of the above embodiment does not particularly limit the method for generating the ions to be measured.

Furthermore, the quadrupole mass spectrometer of the above embodiment only needs to use a quadrupole mass filter as at least one of the mass separators. Therefore, this quadrupole mass spectrometer includes a very general single-type quadrupole mass spectrometer, as well as a triple quadrupole mass spectrometer and a quadrupole-time-of-flight mass spectrometer.

In addition, it may be provided with either or both of pre-rod electrodes and post-rod electrodes before and after the main rod electrodes that contribute to the mass separation of ions.

Furthermore, in the method for manufacturing a quadrupole mass filter of the above embodiment, the cross-sectional shape of the “rod-shaped member” is not particularly limited, but generally, rod materials with a circular or square cross-section are easily available.

Furthermore, in the method for manufacturing a quadrupole mass filter of the above embodiment, the method for machining by cutting the side surface or peripheral surface of the rod-shaped member over the longitudinal direction to form a hyperbolic surface is not particularly limited, but it is naturally preferable to use a method that can achieve high dimensional accuracy. Specifically, one or a combination of mechanical machining including cutting, grinding, and polishing, electrical discharge machining, etching, etc., can be used.

### Configuration and Schematic Operation of a Quadrupole Mass Spectrometer as an Embodiment

Hereinafter, a single quadrupole mass spectrometer according to an embodiment of the present invention and a quadrupole mass filter used therein will be described with reference to the accompanying drawings.

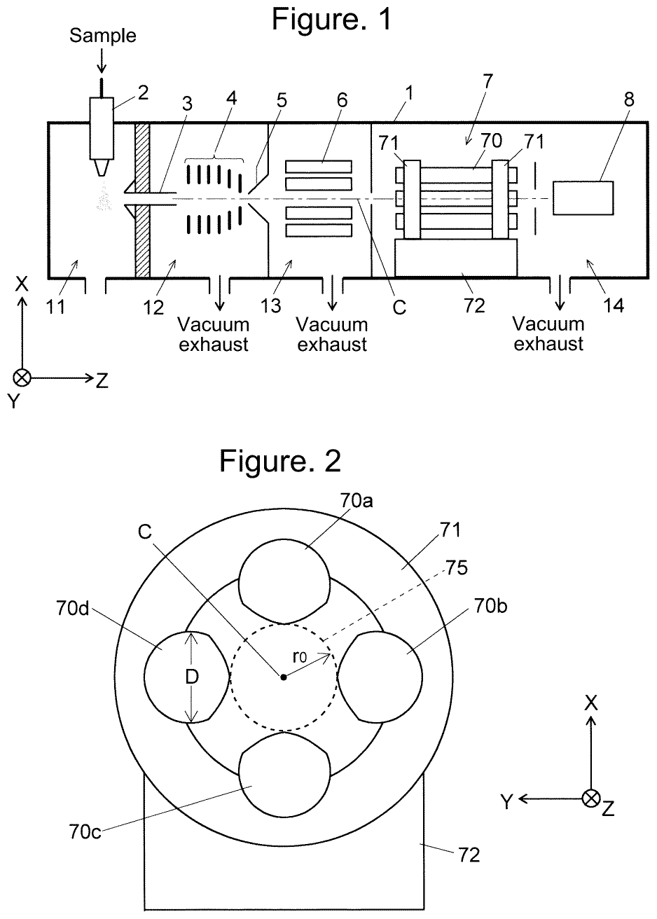

FIG. 1 is a schematic configuration diagram of the main parts of the single quadrupole mass spectrometer of the present embodiment. For convenience of explanation, three mutually orthogonal axes, X, Y, and Z, are set in space as shown in FIG. 1.

As shown in FIG. 1, this quadrupole mass spectrometer has a chamber 1, and the inside of the chamber 1 is roughly divided into four chambers: an ionization chamber 11, a first intermediate vacuum chamber 12, a second intermediate vacuum chamber 13, and an analysis chamber 14. The inside of the ionization chamber 11 is at approximately atmospheric pressure, and each chamber from the first intermediate vacuum chamber 12 onward is evacuated by a rotary pump (not shown) or a combination of a rotary pump and a turbo molecular pump.

An electrospray ionization (ESI) probe 2 is disposed in the ionization chamber 11, and the ionization chamber 11 and the first intermediate vacuum chamber 12 communicate through a desolvation capillary 3 heated to a high temperature. A first ion guide 4 is disposed in the first intermediate vacuum chamber 12, and the first intermediate vacuum chamber 12 and the second intermediate vacuum chamber 13 communicate through a small hole provided at the top of a skimmer 5. In the second intermediate vacuum chamber 13, a multipole-type second ion guide 6 composed of a plurality of rod electrodes is disposed. In the analysis chamber 14, a quadrupole mass filter 7 including four rod electrodes 70 and an ion detector 8 are disposed along the ion optical axis C.

During analysis, predetermined voltages are applied to the ESI probe 2, the desolvation capillary 3, the ion guides 4 and 6, the skimmer 5, the quadrupole mass filter 7, and the ion detector 8 from a power supply circuit (not shown), respectively. When a sample solution containing components to be measured is introduced into the ESI probe 2, charged sample droplets are sprayed into the ionization chamber 11 from the tip of the ESI probe 2. As the charged droplets collide with the surrounding gas and are atomized, and the solvent in the droplets vaporizes, the component molecules contained in the sample droplets are ionized. The ions thus generated are drawn into the desolvation capillary 3 and sent to the first intermediate vacuum chamber 12.

The ions introduced into the first intermediate vacuum chamber 12 are focused near the small hole of the skimmer 5 by the action of the electric field formed by the first ion guide 4, pass through the small hole, and enter the second intermediate vacuum chamber 13. The ions are focused and transported by the action of the electric field formed by the second ion guide 6 and enter the analysis chamber 14. In the analysis chamber 14, ions derived from the sample components enter the space surrounded by the four rod electrodes 70 of the quadrupole mass filter 7, and only ions having an m/z corresponding to the voltage applied to those rod electrodes 70 pass through the space and enter the ion detector 8. On the other hand, other ions diverge on the way. That is, in the quadrupole mass filter 7, ions with a specific m/z are selected. The ion detector 8 outputs an ion intensity signal of a magnitude corresponding to the amount of incident ions to a data processing unit (not shown).

### Structure of the Quadrupole Mass Filter

FIG. 2 is a schematic plan view of the quadrupole mass filter 7 in FIG. 1 when viewed from the left in the Z-axis direction.

As shown in FIG. 2, four rod electrodes 70 (70a, 70b, 70c, 70d, hereinafter, the reference numerals “70a, 70b, 70c, 70d” are used when referring to individual rod electrodes, and the reference numeral “70” is used when referring to a common rod electrode) made of a conductor such as stainless steel are arranged parallel to each other and at 90° angular intervals in the circumferential direction so as to be tangent to a virtual circle 75 with a radius r₀ centered on the central axis, which is also the ion optical axis C. The cross-sectional shape of each rod electrode 70 is substantially cylindrical, but the portion of its peripheral surface facing the ion optical axis C is formed into a hyperbolic surface by cutting a part of the circle as described later. The hyperbolic surface here is a curved surface in which the contour of the rod electrode 70 on the X-Y plane is hyperbolic, and the hyperbolic contour is continuous in the Z-axis direction between both ends of the rod electrode 70. The maximum distance in the cross-section of each rod electrode 70 is D, and in this case, this D is the radius of the circle before being cut into a hyperbolic surface.

The four rod electrodes 70 are held by a substantially annular rod holder (holding member) 71 made of an insulator such as ceramic. By mounting each rod electrode 70 at a predetermined position of this rod holder 71 and fixing it with, for example, a screw, the position of the four rod electrodes 70 around the ion optical axis C is determined. As shown in FIG. 1, the rod holders 71 are provided at two locations, front and rear, along the Z-axis, and the two rod holders 71 are fixed on a base 72.

Note that the structure for fixing the rod electrodes 70 at a predetermined position is not limited to that described in this example, and various structures can be adopted. For example, instead of holding a part of the peripheral surface of each rod electrode 70 with the rod holder 71 as in this example, a structure that holds both front and rear end portions or one end portion of each rod electrode 70 may be adopted. Further, instead of a structure in which the rod electrodes 70 and the rod holder 71 are placed on the base 72, it is also conceivable to have a structure in which they are suspended from above, or a structure in which the rod electrodes 70 are fixed to a wall surface located in front of and/or behind the rod electrodes 70 (in the example of FIG. 1, the wall surface separating the second intermediate vacuum chamber 13 and the analysis chamber 14).

In the quadrupole mass filter 7 of this embodiment, the four rod electrodes 70 having the shape described above have an appropriate length in the range of 80 mm or more and 120 mm or less. This rod length is shorter than that of the rod electrodes constituting a quadrupole mass filter in a general quadrupole mass spectrometer. To obtain high mass resolution, it is advantageous for the rod electrodes to be as long as possible, but as will be described later, the present inventor has confirmed that even with such relatively short rod electrodes 70, sufficient performance can be secured in terms of mass resolution and the like. The radius r₀ of the virtual circle 75 to which the rod electrodes 70 are tangent is set in the range of about 2 to 6 mm, and the maximum distance D in the cross-section of the rod electrodes 70 is set in the range of about 7 to 12 mm.

The voltage applied to each rod electrode 70 of the quadrupole mass filter 7 having such a structure is the same as in the conventional case. That is, a voltage of +(U+Vcosωt) +Vbias, which is a superposition of an RF voltage +Vcosωt and a DC bias voltage Vbias on a DC voltage +U, is applied to a pair of rod electrodes 70a and 70c facing each other across the ion optical axis C. A voltage of −(U+Vcosωt)+Vbias, which is a superposition of an RF voltage −Vcosωt with an inverted phase from the RF voltage +Vcosωt and a common DC bias voltage Vbias on a DC voltage −U with a different polarity from the DC voltage +U, is applied to the other pair of rod electrodes 70b and 70d. U and V determine the m/z of the ions to be passed. On the other hand, Vbias affects the velocity of the ions incident on the quadrupole mass filter 7 and, as described later, affects the number of oscillations of the ions attempting to pass through the quadrupole mass filter 7. Generally, the frequency of the RF voltage is set in the range of about 0.8 to 1.6 MHz, and the DC bias voltage Vbias is set in the range of about −1 to −7 V (however, this polarity is for positive ions, and the polarity is different for negative ions).

### Method for Manufacturing Quadrupole Mass Filter

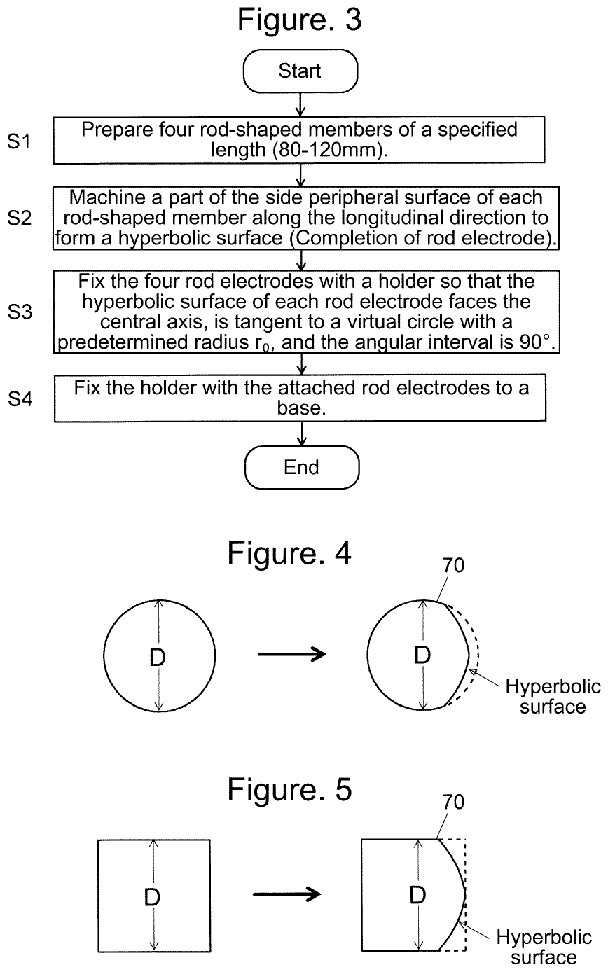

The procedure for manufacturing the above quadrupole mass filter 7 will be described with reference to FIGS. 3 to 5. FIG. 3 is a flowchart showing an example of the manufacturing procedure, and FIGS. 4 and 5 are schematic diagrams showing examples of machining of the rod electrodes.

First, the manufacturer prepares four rod-shaped members made of a conductor of a specified length (step S1). This specified length is a determined length in the range of 80 mm or more and 120 mm or less. The cross-sectional shape of the rod-shaped member is arbitrary, but the most commonly available is a round bar material (stainless steel) with a circular cross-section. The left side of FIG. 4 shows the cross-section of this rod-shaped member.

Next, the manufacturer machines a part of the peripheral or side surface of each rod-shaped member over its entire length in the longitudinal direction by a predetermined method to form a hyperbolic surface (step S2). This rod-shaped member with the hyperbolic surface formed is the rod electrode 70. The machining method is not particularly limited as long as it can form a hyperbolic surface with high precision, but any of mechanical machining including cutting, grinding, and polishing, electrical discharge machining, etching, or a combination thereof can be used. The right side of FIG. 4 shows a cross-section of a case where a hyperbolic surface is formed by cutting the peripheral surface of a rod-shaped member with a circular cross-section.

In a conventional general quadrupole mass filter, the length of the rod electrodes is 130 mm or more, and typically about 200 mm. In contrast, the length of the rod electrodes used here is in the range of 80 mm or more and 120 mm or less, which is as short as about ⅓ to ⅗ of the standard rod length. According to the inventor's study, when trying to machine a part of the peripheral or side surface of a rod-shaped member of about 200 mm or more over its entire length in the longitudinal direction into a hyperbolic shape as shown in FIG. 4, the rod-shaped member is prone to bending during the machining process. This bending leads to a decrease in the accuracy of the shape of the hyperbolic surface and greatly reduces the yield during manufacturing. In contrast, if the length of the rod electrodes is 120 mm or less, it is possible to suppress the bending of the rod-shaped member during machining to a level that is not practically a problem. As a result, sufficiently high dimensional accuracy can be ensured for the shape of the hyperbolic surface.

After that, the manufacturer fixes the four rod electrodes 70 with the rod holder 71 such that the hyperbolic surfaces of the four rod electrodes 70 each face the central axis, the apex of the hyperbolic surfaces is tangent to the virtual circle 75, the angular interval between adjacent rod electrodes 70 in the circumferential direction is 90°, and each rod electrode 70 is parallel to the central axis (ion optical axis C) (step S3). Here, since arc-shaped rod mounting portions for mounting the four rod electrodes 70 are formed on the rod holder 71, by mounting each rod electrode 70 to its respective rod mounting portion and fixing it with a screw or the like, the position and circumferential orientation of each rod electrode 70 can be appropriately determined.

The manufacturer completes the quadrupole mass filter 7 as shown in FIGS. 1 and 2 by placing these assembled rod electrodes 70 on the base 72 and fixing them with screws or fastening members (step S4).

As described above, by forming the rod electrodes 70 using rod-shaped members that are shorter than conventional ones, from 80 to 120 mm, it is possible to obtain a quadrupole mass filter 7 in which the surface of each rod electrode 70 facing the central axis is a hyperbolic surface with high dimensional accuracy. This makes it possible to form an ideal quadrupole electric field in the space surrounded by the rod electrodes 70 during analysis. Furthermore, although the rod electrodes 70 are short, by appropriately setting parameters such as the DC bias voltage Vbias as described later, a sufficient number of oscillations of the ions attempting to pass through the quadrupole mass filter 7 can also be ensured. This makes it possible to enhance the detection sensitivity while ensuring mass resolution and good peak shape that are equivalent to or better than conventional ones. In addition, the yield in manufacturing the rod electrodes is improved, and the cost of the rod-shaped members themselves is reduced due to the shorter rod length, which can lower the cost of the mass spectrometer. Furthermore, the shorter quadrupole mass filter 7 also has the advantage of shortening the length (depth) of the mass spectrometer in the Z-axis direction, making the apparatus smaller and lighter.

### Experiment for Examining Rod Length

In order to investigate how the length of the rod electrodes affects the performance of mass analysis when a quadrupole mass filter is manufactured according to the procedure described above, the present inventor prototyped a plurality of quadrupole mass filters that differ only in rod length and conducted a comparative experiment under the same conditions. The main conditions are as follows.
Length of rod electrode (L): 80 mm, 120 mm, 200 mm (conventional standard length)
Maximum diameter in the cross-section of the rod electrode: 10 mm
Radius r₀ of the virtual circle to which the rod electrodes are tangent: 4 mm
Frequency (f) of the RF voltage applied to the rod electrodes: 1.2 MHz

On the other hand, as described above, the length of the rod electrodes affects the number of oscillations of the ions passing through the space surrounded by the rod electrodes, and this number of oscillations affects the mass resolution. Therefore, the value of the DC bias voltage Vbias commonly applied to the four rod electrodes was adjusted so that the number of oscillations would be approximately the same even when the length of the rod electrodes was different. The reason why the number of oscillations changes when this DC bias voltage Vbias is changed is that changing the DC bias voltage Vbias changes the potential difference between it and the DC bias voltage applied to the upstream second ion guide 6, that is, the energy received by the ions changes, and the velocity of the ions incident on the quadrupole mass filter 7 changes. When this ion velocity changes, the residence time of the ions in the space surrounded by the rod electrodes 70 changes, and as a result, the number of oscillations also changes. Here, the relative value of the DC bias voltage Vbias when using rod electrodes with a rod length of 200 mm was set to 1, the relative value of the DC bias voltage Vbias when using rod electrodes with a rod length of 120 mm was set to 0.71, and the relative value of the DC bias voltage Vbias when using rod electrodes with a rod length of 80 mm was set to 0.5.

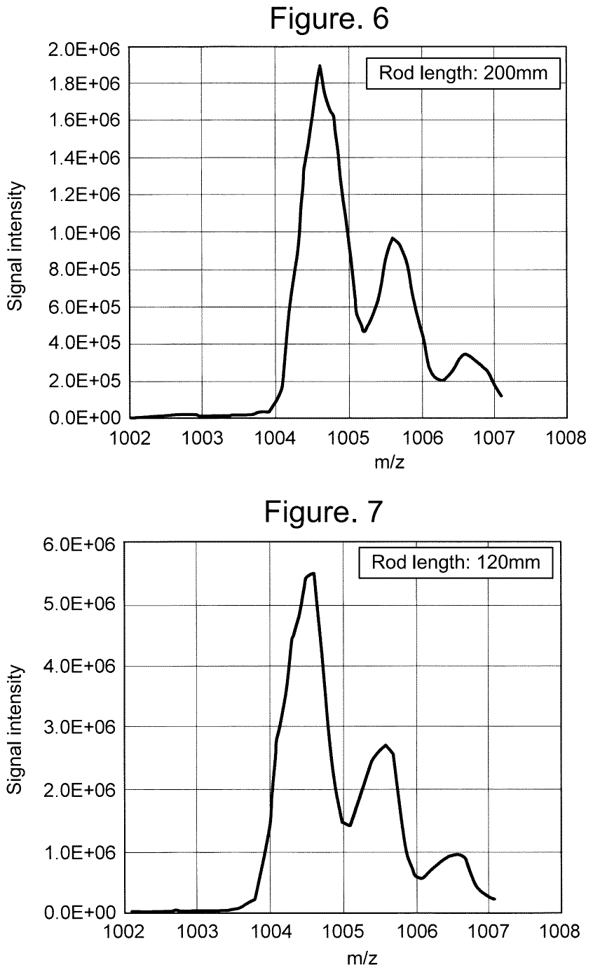

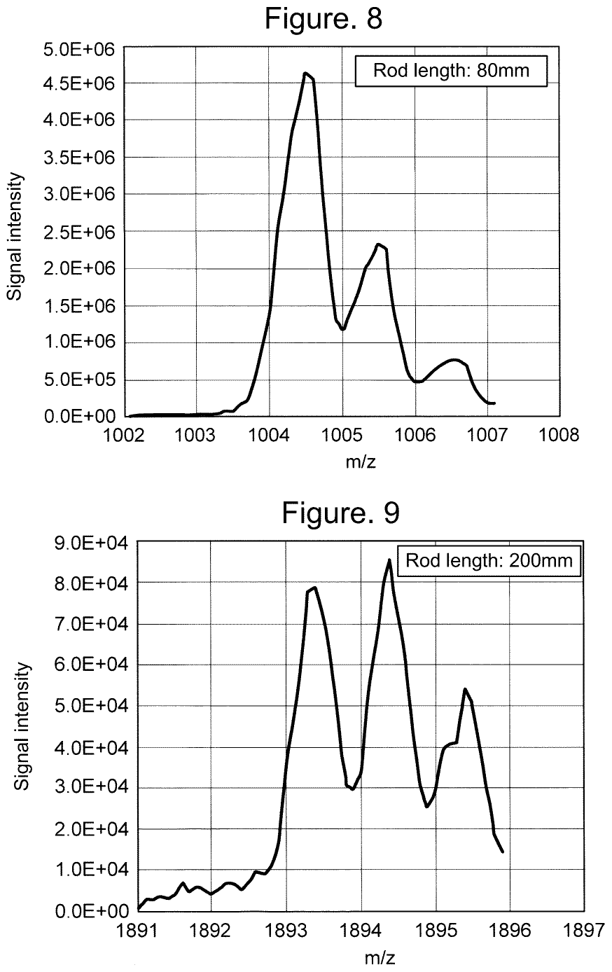

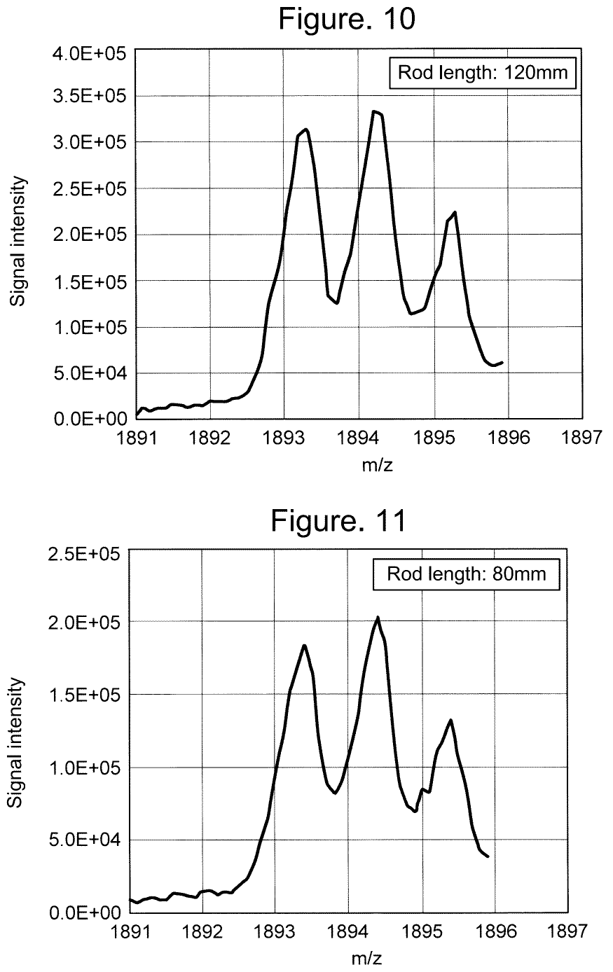

FIGS. 6 to 8 are measured waveforms of the peak for PEG with m/z 1004.6 when the rod lengths are 200 mm, 120 mm, and 80 mm, respectively. FIGS. 9 to 11 are measured waveforms of the peak for PEG with m/z 1893.4 when the rod lengths are 200 mm, 120 mm, and 80 mm, respectively. The three peaks observed in each figure are the monoisotopic peak and isotopic peaks.

From FIGS. 6 to 11, it can be seen that for both m/z 1004.6 and m/z 1893.4, the signal intensity increases for rod lengths of 120 mm and 80 mm compared to a rod length of 200 mm. In addition, it can be confirmed that for both rod lengths of 120 mm and 80 mm, the full width at half maximum of the peak can be adjusted to approximately the same value of 0.7 u, and the isotopes can be sufficiently separated.

Now, if the charge is e, the mass of the ion is m, the velocity of the ion passing through the rod electrodes is v, and the DC bias voltage (accelerating voltage) is E, the following theoretical relationship holds.

$$( 1 / 2 ) {mv}^{2} = eE$$

$$v = √ ( 2 eE / m )$$

The number of oscillations N of the ion while passing through the space surrounded by the rod electrodes is

$$N = ft = fL √ ( m / 2 eE ) \qquad ( 1 )$$

According to equation (1), in order to make the number of ion oscillations N the same, when the DC bias voltage Vbias (relative value) for a rod length of 200 mm is 1, the DC bias voltage Vbias (relative value) for a rod length of 120 mm is 0.36, and the DC bias voltage Vbias (relative value) for a rod length of 80 mm is 0.16. In other words, this indicates that in reality, even if the DC bias voltage Vbias is made larger than the theoretical value (not made that small), performance such as high mass resolution and good peak shape can be maintained. It can be inferred that this is due to the improvement in the machining accuracy of the hyperbolic surface of the rod electrodes by shortening the length without changing the maximum distance D in the cross-section of the rod electrodes (the cross-sectional diameter of the rod-shaped member) from the conventional one.

Although experimental verification has not been performed for rod lengths other than 200 mm, 120 mm, and 80 mm, from the above results, it is considered that when the rod length exceeds 120 mm, the machining accuracy of the hyperbolic surface becomes a problem due to the factor of bending of the rod-shaped member when forming the hyperbolic surface. On the other hand, if the rod length is made shorter than 80 mm, there is a concern that a sufficient number of oscillations, which affects the mass resolution, cannot be secured. Therefore, considering these points together, it can be concluded that a reasonable range for the rod length is 80 mm or more and 120 mm or less.

In the above embodiment, the rod electrodes 70 were formed from a round bar material, but a hyperbolic surface may also be formed by cutting a part of the side surface of a rod-shaped member having a square or rectangular cross-section (or any other quadrangular shape) as shown in FIG. 5. The cross-sectional shape of the rod-shaped member is not limited to this and can be arbitrary.

Furthermore, the above embodiment is merely an example of the present invention, and it is clear that appropriate modifications, additions, and corrections may be made within the spirit of the present invention, beyond the various modifications already mentioned, and are included in the scope of the claims of the present application.

### Various Aspects

Those skilled in the art will understand that the exemplary embodiments described above are specific examples of the following aspects.

(Item 1) One aspect of the method for manufacturing a quadrupole mass filter according to the present invention is a method for manufacturing a quadrupole mass filter used in a mass spectrometer, comprising:
a first step of forming a hyperbolic surface by cutting at least a part of a side surface or a peripheral surface of each of four rod-shaped members over an entire length in a longitudinal direction, each of the four rod-shaped members having a length in a range of 80 mm or more and 120 mm or less; and
a second step of positioning and fixing the four rod-shaped members, on which the hyperbolic surfaces are respectively formed, as rod electrodes using a holding member, such that the four rod electrodes surround a central axis and the hyperbolic surface of each rod electrode faces the central axis.

(Item 7) Furthermore, one aspect of the quadrupole mass spectrometer according to the present invention comprises a quadrupole mass filter that separates ions to be measured according to m/z, wherein the quadrupole mass filter includes:
four rod electrodes having a length along a central axis in a range of 80 mm or more and 120 mm or less, and at least the surface facing the central axis being a hyperbolic surface; and
a holding member that fixes the four rod electrodes so as to surround the central axis in a state where the hyperbolic surface of each rod electrode faces the central axis.

According to the method for manufacturing a quadrupole mass filter described in item 1 and the quadrupole mass spectrometer described in item 7, by making the rod electrodes shorter, 120 mm or less, compared to a conventional general quadrupole mass filter, a hyperbolic surface with good precision can be obtained with a yield that is satisfactory in terms of cost. Furthermore, by making the length of the rod electrodes 80 mm or more, the rod length necessary for the separation and selection of the target ions can be secured. As a result, in the method for manufacturing a quadrupole mass filter described in item 1 and the quadrupole mass spectrometer described in item 7, the detection sensitivity can be improved while maintaining mass resolution and good peak shape equal to or better than the conventional ones, and the cost can also be sufficiently suppressed.

(Item 2) The method for manufacturing a quadrupole mass filter according to item 1, wherein in the second step, the four rod electrodes may be fixed so as to be tangent to a virtual circle with a radius of 2 to 6 mm centered on the central axis.

(Item 3) The method for manufacturing a quadrupole mass filter according to item 2, wherein the four rod electrodes produced in the first step may have a longest distance of 7 to 12 mm in a direction parallel to a tangent line to the virtual circle at the point of contact with the rod electrode, in a cross-section of each rod electrode.

(Item 8) In the quadrupole mass spectrometer according to item 7, the four rod electrodes may be tangent to a virtual circle with a radius of 2 to 6 mm centered on the central axis.

(Item 9) In the quadrupole mass spectrometer according to item 8, the four rod electrodes may have a longest distance of 7 to 12 mm in a direction parallel to a tangent line to the virtual circle at the point of contact with the rod electrode, in a cross-section of each rod electrode.

According to the method for manufacturing a quadrupole mass filter described in items 2 and 3, and the quadrupole mass spectrometer described in items 8 and 9, since other dimensions except for the length of the rod electrodes can be made comparable to those of a conventional mass spectrometer, the basic configuration and structure of the apparatus can be inherited.

(Item 4) The method for manufacturing a quadrupole mass filter according to any one of items 1 to 3, wherein in the first step, the hyperbolic surface may be formed by mechanical machining. The mechanical machining here includes grinding and cutting.

(Item 5) Furthermore, the method for manufacturing a quadrupole mass filter according to any one of items 1 to 3, wherein in the first step, the hyperbolic surface may be formed by electrical discharge machining.

(Item 6) Furthermore, the method for manufacturing a quadrupole mass filter according to any one of items 1 to 3, wherein in the first step, the hyperbolic surface may be formed by etching.

According to the method for manufacturing a quadrupole mass filter described in any one of items 4 to 6, a good hyperbolic surface can be formed with high precision.

(Item 10) The quadrupole mass spectrometer according to any one of items 7 to 9 may further comprise a voltage application unit that applies a voltage to each rod electrode of the quadrupole mass filter, wherein the voltage application unit may apply an RF voltage with a frequency in the range of 0.8 to 1.6 MHz.

(Item 11) The quadrupole mass spectrometer according to any one of items 7 to 10 may further comprise a voltage application unit that applies a voltage to each rod electrode of the quadrupole mass filter, wherein the voltage application unit may apply a DC bias voltage with a voltage value of −1 to −7 V.

According to the quadrupole mass spectrometer described in items 10 and 11, since the voltage applied to the rod electrodes may be comparable to that of a conventional mass spectrometer, the electrical circuits such as the voltage application unit can be inherited from conventional ones.

(Item 12) Furthermore, in the quadrupole mass spectrometer according to any one of items 7 to 11, the maximum value of the m/z range may be in the range of 1000 to 2000.

(Item 13) In the quadrupole mass spectrometer according to any one of items 7 to 12, the full width at half maximum of a peak in a mass spectrum may be 0.2 to 1.2 u.

### REFERENCE SIGNS LIST

1 . . . Chamber
11 . . . Ionization chamber
12, 13 . . . Intermediate vacuum chamber
14 . . . Analysis chamber
2 . . . ESI probe
3 . . . Desolvation capillary
4, 6 . . . Ion guide
5 . . . Skimmer
7 . . . Quadrupole mass filter
70 . . . Rod electrode
71 . . . Rod holder
72 . . . Base
75 . . . Virtual circle
8 . . . Ion detector
C . . . Ion optical axis (Central axis)

1. A method for manufacturing a quadrupole mass filter used in a mass spectrometer, comprising:
a first step of forming a hyperbolic surface by cutting at least a part of a side surface or a peripheral surface of each of four rod-shaped members over an entire length in a longitudinal direction, each of the four rod-shaped members having a length in a range of 80 mm or more and 120 mm or less; and
a second step of positioning and fixing the four rod-shaped members, on which the hyperbolic surfaces are respectively formed, as rod electrodes using a holding member, such that the four rod electrodes surround a central axis and the hyperbolic surface of each rod electrode faces the central axis.

2. The method for manufacturing a quadrupole mass filter according to claim 1, wherein in the second step, the four rod electrodes are fixed so as to be tangent to a virtual circle with a radius of 2 to 6 mm centered on the central axis.

3. The method for manufacturing a quadrupole mass filter according to claim 2, wherein the four rod electrodes produced in the first step have a longest distance of 7 to 12 mm in a direction parallel to a tangent line to the virtual circle at the point of contact with the rod electrode, in a cross-section of each rod electrode.

4. The method for manufacturing a quadrupole mass filter according to claim 1, wherein in the first step, the hyperbolic surface is formed by mechanical machining.

5. The method for manufacturing a quadrupole mass filter according to claim 1, wherein in the first step, the hyperbolic surface is formed by electrical discharge machining.

6. The method for manufacturing a quadrupole mass filter according to claim 1, wherein in the first step, the hyperbolic surface is formed by etching.

7. A quadrupole mass spectrometer comprising a quadrupole mass filter that separates ions to be measured according to a mass-to-charge ratio, wherein the quadrupole mass filter includes:
four rod electrodes having a length along a central axis in a range of 80 mm or more and 120 mm or less, and at least a surface facing the central axis being a hyperbolic surface; and
a holding member that fixes the four rod electrodes so as to surround the central axis in a state where the hyperbolic surface of each rod electrode faces the central axis.

8. The quadrupole mass spectrometer according to claim 7, wherein the four rod electrodes are tangent to a virtual circle with a radius of 2 to 6 mm centered on the central axis.

9. The quadrupole mass spectrometer according to claim 8, wherein the four rod electrodes have a longest distance of 7 to 12 mm in a direction parallel to a tangent line to the virtual circle at the point of contact with the rod electrode, in a cross-section of each rod electrode.

10. The quadrupole mass spectrometer according to claim 7, further comprising a voltage application unit that applies a voltage to each rod electrode of the quadrupole mass filter, wherein the voltage application unit applies an RF voltage with a frequency in a range of 0.8 to 1.6 MHz.

11. The quadrupole mass spectrometer according to claim 7, further comprising a voltage application unit that applies a voltage to each rod electrode of the quadrupole mass filter, wherein the voltage application unit applies a DC bias voltage with a voltage value of −1 to −7 V.

12. The quadrupole mass spectrometer according to claim 7, wherein a maximum value of a mass-to-charge ratio range is in a range of 1000 to 2000.

13. The quadrupole mass spectrometer according to claim 7, wherein a full width at half maximum of a peak in a mass spectrum is 0.2 to 1.2 u.
